(19) United States
(12) Patent Application Publication
(10) Pub. No.: US 2024/0212899 A1
(43) Pub. Date: Jun. 27, 2024

(54) ANISOTROPIC SAMARIUM-IRON-NITROGEN MAGNETIC ALLOY POWDER AND PREPARATION METHOD THEREFOR

(71) Applicants: GRIREM HI-TECH CO., LTD., Langfang (CN); GRIREM ADVANCED MATERIALS CO., LTD., Beijing (CN)

(72) Inventors: Haijun PENG, Beijing (CN); Yang LUO, Beijing (CN); Zilong WANG, Beijing (CN); Shengjie ZHU, Beijing (CN); Dunbo YU, Beijing (CN); Hongbin ZHANG, Beijing (CN); Weikang SHAN, Beijing (CN); Tianjiao MA, Beijing (CN); Shuai CUI, Beijing (CN)

(73) Assignees: GRIREM HI-TECH CO., LTD., Langfang (CN); GRIREM ADVANCED MATERIALS CO., LTD., Beijing (CN)

(21) Appl. No.: 18/486,470

(22) Filed: Oct. 13, 2023

(30) Foreign Application Priority Data
Dec. 26, 2022 (CN) 202211678918.2

(51) Int. Cl. H01F 1/059; B22F 1/05; B22F 1/065; B22F 1/142; B22F 1/145; B22F 9/22; C22C 33/02; C22C 38/00

(52) U.S. Cl. CPC H01F 1/059; B22F 1/05; B22F 1/065; B22F 1/142; B22F 1/145; B22F 9/22; C22C 33/0235; C22C 38/001; C22C 38/005; B22F 2201/016; B22F 2201/02; B22F 2201/20; B22F 2301/355; B22F 2304/10; B22F 2998/10; B22F 2999/00; C22C 2202/02

(57) ABSTRACT

Disclosed are anisotropic samarium-iron-nitrogen magnetic alloy powder and a preparation method therefor. The anisotropic samarium-iron-nitrogen magnetic alloy powder has a chemical formula of Sm2Fe17N3, and has a Th₂Zn₁₇ crystal structure. In the alloy powder, the granularity is: D90≤5 μm and D10≥0.5 μm, the average sphericity ≥0.7, the coercivity Hcj≥10 kOe, and the square degree Q≥0.5. The preparation method includes: S1: mixing iron powder, samarium oxide powder and calcium granules uniformly; S2: placing the mixture into a rotating heat treatment furnace, adding high-temperature-resistant balls, performing vacuumizing, introducing a reductive diffusion protective gas, and heating a furnace body; S3: cooling the furnace body, performing vacuumizing, and introducing a nitriding gas; and S4: taking out and separating the cooled powder and balls, washing the powder, and drying the powder in a vacuum environment to obtain the anisotropic samarium-iron-nitrogen magnetic alloy powder.

### CROSS-REFERENCE TO RELATED APPLICATIONS

This application claims priority to Chinese Patent Application No. CN202211678918.2 filed on Dec. 26, 2022, the content of which is incorporated herein by reference in its entirety.

### TECHNICAL FIELD

The present application relates to the technical field of magnetic alloy powder, and in particular to, anisotropic samarium-iron-nitrogen magnetic alloy powder and a preparation method therefor.

### BACKGROUND

An anisotropic Sm₂Fe₁₇N₃ material has magnetic property comparable to a Nd₂Fe₁₄B material and higher Curie temperature, but the price of Sm is only one tenth of Nd or even lower, so the Sm₂Fe₁₇N₃ material has great application potential. A well-known method for preparing a Sm₂Fe₁₇N₃ material is to prepare Sm₂Fe₁₇ alloy first and then nitride the Sm2Fe17 so as to obtain samarium-iron-nitrogen alloy. At present, the method for preparing a Sm2Fe17N3 method mainly includes a mechanical alloying method, a hydrogenation disproportionation method, a powder metallurgic method, a chemical coprecipitation and a traditional reductive diffusion method. The mechanical alloying method requires long-time high-energy ball milling, which is low in efficiency, high in energy consumption and not conducive to popularization and application. The hydrogenation disproportionation method is mainly used for preparing an isotropous Sm₂Fe₁₇N₃ and is low in magnetic property. The powder metallurgic method requires long-time annealing treatment on smelted SmFe alloy to eliminate a-Fe, and requires fine grinding after nitriding to obtain powder with practical performance. The traditional reductive diffusion method is to mix, raw materials, briquet the mixture and put the mixture into a crucible for reductive diffusion, wash the mixture to obtain Sm₂Fe₁₇ alloy powder, then nitride the alloy powder and finally perform fine grinding to Sm₂Fe₁₇N₃ magnetic powder. The above methods require the fine grinding step. The result of fine grinding and crushing of the powder is that granules are irregular in shape and have many sharp corners, and the surface integrity of the crystalline grain is damaged, so that the coercivity and square degree of the magnetic powder are reduced. In addition, fine grinding is generally performed in an organic solvent, is complex in operation, and has the problem in safety. The chemical coprecipitation method is to add a precipitating agent into a salt solution of Sm and Fe for reaction to obtain a fine-granule composite precipitate, and perform calcining, pre-reduction, reductive diffusion, nitriding and washing to finally obtain Sm₂Fe₁₇N₃ magnetic powder. By the method, the anisotropic Sm₂Fe₁₇N₃ magnetic powder can be obtained without fine grinding, but the method is complex in process flow, difficult in control of Sm content, and not conducive to large-scale promotion.

The magnetic alloy powder has a fixed single-domain size, and has good coercivity only when the grain size is near the single-domain size range. For the Sm₂Fe₁₇N₃ material, the cost is high when the size is reduced to the single-domain size, and the coercivity with the practical effect can be obtained when the size is reduced to a range of several microns. As everyone knows, the coercivity mechanism of the Sm₂Fe₁₇N₃ is a typical nucleation mechanism. In addition to the grain size, the morphology, surface state and other factors of the granules are the important factors affecting the comprehensive properties of the material. The alloy granules are fine and the powder is prone to oxidization, so the improvement of the coercivity and squareness of the material has always been a difficult problem to solve. Based on this, patents CN100513015C, CN110662617A and CN108701518B disclose a method for preparing a powder with a good morphology through chemical coprecipitation, and patent CN108274016A discloses a method for obtaining Sm2Fe17 powder with good sphericity through spray thermal decomposition reduction. The method for controlling the morphology of the Sm2Fe17N3 magnetic powder is complex in process flow, difficult in accurate control of the Sm content, and difficult in large-scale production.

### SUMMARY

An objective of the present application is to provide anisotropic samarium-iron-nitrogen magnetic alloy powder and a preparation method therefor, so that at least one of the above technical problems can be solved, and anisotropic Sm₂Fe₁₇N₃ alloy magnetic powder with good sphericity, particular granularity matching, high coercivity and high square degree can be produced without screening.

Examples of the present application are implemented as follows.

Anisotropic samarium-iron-nitrogen magnetic alloy powder has a chemical formula of Sm₂Fe₁₇N₃ and has a Th₂Zn₁₇ crystal structure, where in the alloy powder, the granularity is: 0.5 μm≤D90≤5 μm and 0.1 μm≤D10≤2 μm, the average sphericity is greater than or equal to 0.7, the coercivity Hcj is greater than or equal to 10 kOe, and the square degree Q is greater than or equal to 0.5.

In a preferred example of the present application, in the anisotropic samarium-iron-nitrogen magnetic alloy powder, the granularity is: 1 μm≤D90≤4 μm and 0.8 μm≤D10≤2 μm, the average sphericity is greater than or equal to 0.8, the coercivity Hcj is greater than or equal to 13 kOe, and the square degree Q is greater than or equal to 0.6.

The granularity of the alloy powder, the statistical value of the granule volume and the statistical value of the granule surface area are all measured by a laser granularity analyzer.

The value of the square degree Q indicates the demagnetization resistance of the magnetic powder.

The technical effect is as follows: the square degree value is significantly increased under the condition of the same grain size, such that the magnetic powder shows more excellent comprehensive magnetic properties.

A preparation method for anisotropic samarium-iron-nitrogen magnetic alloy powder includes:

S1: mixing raw materials: mixing iron powder, samarium oxide powder and calcium granules uniformly to obtain a mixture;

S2: performing reductive diffusion heat treatment: placing the mixture into a rotating heat treatment furnace, adding high-temperature-resistant balls to avoid powder sintering, performing vacuumizing to 1×10⁻²Pa, introducing a reductive diffusion protective gas, heating a furnace body to 850° C.-950° C., and performing heat preservation for 1-3 hours.

The reductive diffusion and nitriding are performed in the rotating heat treatment furnace, and the high-temperature-resistant balls for avoiding powder sintering are added, so that the alloy powder still can basically maintain the granularity and morphology similar to those of the raw material iron powder event after high-temperature heat treatment, thereby greatly facilitating the control of the morphology and granularity of the anisotropic Sm₂Fe₁₇N₃ magnetic alloy powder.

The reductive diffusion and nitriding heat treatment are completed at one step, after the reductive diffusion step is completed, the temperature is directly reduced to a nitriding heat treatment temperature for nitriding, not like the traditional method which is to cool the product to room temperature after the reductive diffusion step is completed, perform crushing, washing and drying, and reheating for nitriding, thereby simplifying the process and saving energy.

S3: performing nitriding heat treatment: cooling the furnace body to 400° C.-500° C., performing vacuumizing to 1×10⁻²Pa, introducing a nitriding protective gas, performing heat preservation for 1-15 hours, performing vacuumizing and heat treatment for 1 hour, and cooling.

S4: washing and drying: taking out and separating the cooled powder and balls, washing the powder, and drying the powder in a vacuum environment to obtain the anisotropic samarium-iron-nitrogen magnetic alloy powder.

In a preferred example of the present application, in the preparation method for the anisotropic samarium-iron-nitrogen magnetic alloy powder, in S1, the granularity of the iron powder is: 0.5 μm≤D90≤5 μm and 0.1 μm≤D10≤2 μm, the sphericity of the iron powder is greater than or equal to 0.7, the granularity of the samarium oxide is: 0.5 μm≤D90≤5 μm, and the size of the calcium granules is greater than or equal to 0.1 mm and less than or equal to 2 mm.

In a preferred example of the present application, in the preparation method for the anisotropic samarium-iron-nitrogen magnetic alloy powder, in S1, the granularity of the iron powder is: 1 μm≤D90≤4 μm and 0.8 μm≤D10≤2 μm, the sphericity of the iron powder is greater than or equal to 0.8, the granularity of the samarium oxide is: 1 μm≤D90≤4 μm, and the size of the calcium granules is greater than or equal to 0.1 mm and less than or equal to 1mm.

In a preferred example of the present application, in the preparation method for the anisotropic samarium-iron-nitrogen magnetic alloy powder, in S2, the high-temperature-resistant balls account for 20%-80% of the volume of the mixed magnetic alloy powder, and the diameter of the high-temperature-resistant is 1-5 mm.

In a preferred example of the present application, in the preparation method for the anisotropic samarium-iron-nitrogen magnetic alloy powder, in S2, the high-temperature-resistant balls account for 40%-60% of the volume of the mixed magnetic alloy powder, and the diameter of the high-temperature-resistant is 2-3 mm.

In a preferred example of the present application, in the preparation method for the anisotropic samarium-iron-nitrogen magnetic alloy powder, in S2, the high-temperature-resistant balls adopt hard allow balls, zirconia balls or corundum balls.

In the preferred example of the present application, in the preparation method for the anisotropic samarium-iron-nitrogen magnetic alloy powder, in S2, the furnace body of the heat treatment furnace rotates at a speed of 5-20 r/min.

In a preferred example of the present application, in the preparation method for the anisotropic samarium-iron-nitrogen magnetic alloy powder, in S3, the nitriding protective gas adopts nitrogen or a mixed gas of nitrogen and hydrogen or an ammonia gas or a mixed gas of an ammonia gas and hydrogen.

In a preferred example of the present application, in the preparation method for the anisotropic samarium-iron-nitrogen magnetic alloy powder, in S4, the method for taking out and separating the cooled powder and balls includes: taking out the cooled powder and balls together, performing washing with deionized water under the protection of an inert gas, and separating the high-temperature-resistant balls by a filter screen.

In a preferred example of the present application, in the preparation method for the anisotropic samarium-iron-nitrogen magnetic alloy powder, in S4, the method for washing the powder includes: washing the powder for many times until the solution is clear, dissolving the residual calcium or compound thereof with dilute acetic acid, performing washing with deionized water until the PH value of the washing liquid is 7, and performing washing with absolute ethanol for several times.

The examples of the present application has the following beneficial effects.

In the Sm₂Fe₁₇N₃ magnetic alloy powder provided by the present application, through optimized granularity matching and good powder morphology, the square degree value is significantly increased under the condition of the same grain size, such that the magnetic powder shows more excellent comprehensive magnetic properties; in the preparation method provided by the present application, reductive diffusion and nitriding are performed in the rotating heat treatment furnace, and the high-temperature-resistant balls for avoiding powder sintering are added, so that the alloy powder still can basically maintain the granularity and morphology similar to those of the raw material iron powder event after high-temperature heat treatment, thereby greatly facilitating the control of the morphology and granularity of the anisotropic Sm₂Fe₁₇N₃; the reductive diffusion and nitriding heat treatment are completed at one step, after the reductive diffusion step is completed, the temperature is directly reduced to a nitriding heat treatment temperature for nitriding, not like the traditional method which is to cool the product to room temperature after the reductive diffusion step is completed, perform crushing, washing and drying, and reheating for nitriding, thereby simplifying the process and saving energy; and the iron powder with superfine granularity and high sphericity is adopted, and the magnetic alloy powder obtained by the preparation method provided by the present application basically inherits the granularity and morphology of the iron powder, thereby avoiding the fine-grinding step that is necessarily performed in the past to achieve high coercivity, simplifying the process and avoiding the safety problem easily caused by the use of the organic solvent.

### BRIEF DESCRIPTION OF DRAWINGS

To describe the technical solutions of the examples of the present application more clearly, a brief description of the accompanying drawings required for describing the examples will be provided below. It should be understood that the following accompanying drawings show merely some examples of the present application and thus should not be considered as limiting the scope. Those of ordinary skill in the art can also derive other accompanying drawings from these accompanying drawings without making creative efforts.

FIG. 1 is a schematic flowchart of a preparation method for anisotropic samarium-iron-nitrogen magnetic alloy powder according to the present application.

FIG. 2 is a scanning electron microscope schematic diagram of iron powder used in an example in a preparation method for anisotropic samarium-iron-nitrogen magnetic alloy powder according to the present application.

FIG. 3 is a scanning electron microscope schematic diagram of anisotropic Sm₂Fe₁₇N₃ magnetic alloy powder prepared by an example of the present application.

FIG. 4 is a scanning electron microscope schematic diagram of anisotropic Sm₂Fe₁₇N₃ magnetic alloy powder in a comparative example of the present application.

### DETAILED DESCRIPTION OF THE EMBODIMENTS

To make the objectives, technical solutions and advantages of the examples of the present application clearer, the technical solutions in the examples of the present application are described below clearly and completely with reference to the accompanying drawings in the examples of the present application. Apparently, the described examples are some rather than all of the examples. Generally, components of examples of the present application described and shown in the accompanying drawings can be arranged and designed in various manners.

A first example of the present application provides anisotropic samarium-iron-nitrogen magnetic alloy powder, having a chemical formula of Sm₂Fe₁₇N₃ and having a Th₂Zn₁₇ crystal structure, where in the alloy powder, the granularity is: 0.5 μm≤D90≤5 μm and 0.1 μm≤D10≤2 μm, the average sphericity is greater than or equal to 0.7, the coercivity Hcj is greater than or equal to 10 kOe, and the square degree Q is greater than or equal to 0.5.

Specifically, in the anisotropic samarium-iron-nitrogen magnetic alloy powder, the granularity is: 1 μm≤D90≤4 μm and 0.8 μm≤D10≤2 μm, the average sphericity is greater than or equal to 0.8, the coercivity Hcj is greater than or equal to 13 kOe, and the square degree Q is greater than or equal to 0.6.

The sphericity formula is: the sphericity is equal to 4π(3Vₚ/4π)^{2/3}/Sp and used to express the sphericity of the granule, where Vp is granule volume, and Sp is granule surface area.

The square degree formula is: the square degree Q=Hc/Hcj, where Hc is a corresponding reverse magnetic field intensity when the remanence of the magnetic powder subjected to saturated magnetization is reduced to 90%, and Hcj is a corresponding reverse magnetic field intensity when the remanence of the magnetic powder subjected to saturated magnetization is reduced to 0%.

The granularity of the alloy powder, the statistical value of the granule volume and the statistical value of the granule surface area are all measured by a laser granularity analyzer.

The value of the square degree Q indicates the demagnetization resistance of the magnetic powder.

The technical effect is as follows: the square degree value is significantly increased under the condition of the same grain size, such that the magnetic powder shows more excellent comprehensive magnetic properties.

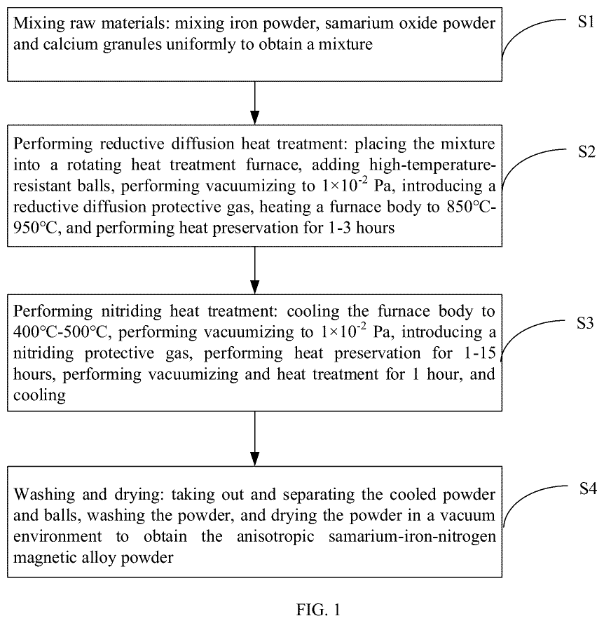

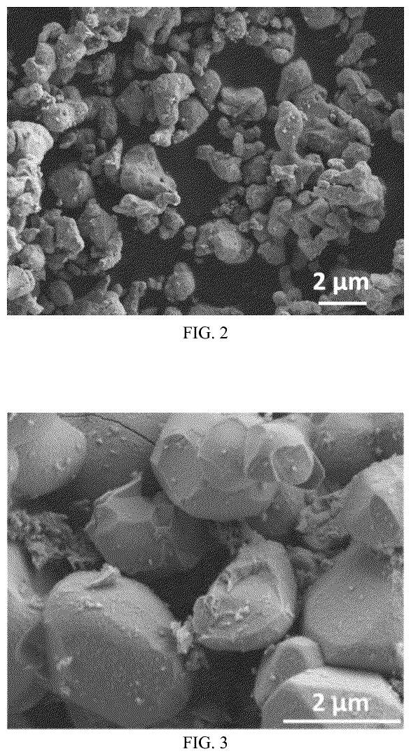

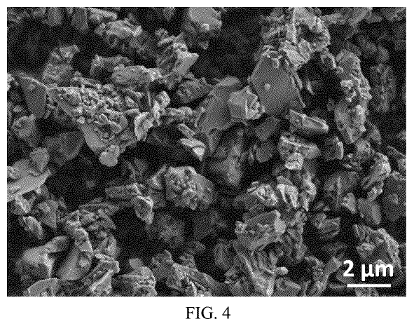

Referring to FIG. 1, a second example of the present application provides a preparation method for anisotropic samarium-iron-nitrogen magnetic alloy powder, including:

S1: mixing raw materials: mixing iron powder, samarium oxide powder and calcium granules uniformly to obtain a mixture.u

Specifically, in S1, the granularity of the iron powder is: D90≤5 μm and D10≥0.5 μm, the sphericity of the iron powder is greater than or equal to 0.7, the granularity of the samarium oxide is: D90≤5 μm, and the size of the calcium granules is less than or equal to 2 mm.

Specifically, in S1, the granularity of the iron powder is: D90≤4 μm and D10≥0.8 μm, the sphericity of the iron powder is greater than or equal to 0.8, the granularity of the samarium oxide is: D90≤4 μm, and the size of the calcium granules is less than or equal to 1 mm.

S2: performing reductive diffusion heat treatment: placing the mixture into a rotating heat treatment furnace, adding high-temperature-resistant balls to avoid powder sintering, perform vacuumizing to 1×10⁻²Pa, introducing a reductive diffusion protective gas, heating a furnace body to 850° C.-950° C., and performing heat preservation for 1-3 hours, where the reductive diffusion protective gas may adopt argon.

Specifically, in S2, the high-temperature-resistant balls account for 20%-80% of the volume of the mixed magnetic alloy powder, and the diameter of the high-temperature-resistant is 1-5 mm.

Specifically, in S2, the high-temperature-resistant balls account for 40%-60% of the volume of the mixed magnetic alloy powder, and the diameter of the high-temperature-resistant is 2-3 mm.

Specifically, in S2, the high-temperature-resistant balls adopt hard allow balls, zirconia balls or corundum balls.

Specifically, in S2, the furnace body of the heat treatment furnace rotates at a speed of 5-20 r/min.

The reductive diffusion and nitriding are performed in the rotating heat treatment furnace, and the high-temperature-resistant balls for avoiding powder sintering are added, so that the alloy powder still can basically maintain the granularity and morphology similar to those of the raw material iron powder event after high-temperature heat treatment, thereby greatly facilitating the control of the morphology and granularity of the anisotropic Sm₂Fe₁₇N₃ magnetic alloy powder.

The reductive diffusion and nitriding heat treatment are completed at one step, after the reductive diffusion step is completed, the temperature is directly reduced to a nitriding heat treatment temperature for nitriding, not like the traditional method which is to cool the product to room temperature after the reductive diffusion step is completed, perform crushing, washing and drying, and reheating for nitriding, thereby simplifying the process and saving energy.

S3: performing nitriding heat treatment: cooling the furnace body to 400° C.-500° C., performing vacuumizing to 1×10⁻²Pa, introducing a nitriding protective gas, performing heat preservation for 1-15 hours, performing vacuumizing and heat treatment for 1 hour, and cooling.

Specifically, in S3, the nitriding protective gas adopts nitrogen or a mixed gas of nitrogen and hydrogen or an ammonia gas or a mixed gas of an ammonia gas and hydrogen.

S4: washing and drying: taking out and separating the cooled powder and balls, washing the powder, and drying the powder in a vacuum environment to obtain the anisotropic samarium-iron-nitrogen magnetic alloy powder.

Specifically, in S4, the method for taking out and separating the cooled powder and balls includes:

take out the cooled powder and balls together, perform washing with deionized water under the protection of an inert gas, and separate the high-temperature-resistant balls by a filter screen.

Specifically, in S4, the method for washing the powder includes:

washing the powder for many times until the solution is clear, dissolve the residual calcium or compound thereof with dilute acetic acid, performing washing with deionized water until the PH value of the washing liquid is 7, and performing washing with absolute ethanol for several times.

The beneficial effects of the present application are further described below with reference to specific experimental examples and comparative examples.

In the following examples, the magnetic property of the alloy magnetic powder is detected by a vibrating sample magnetometer (VSM). The granular morphology of the magnetic powder is observed through a scanning electron microscope. The granularity distribution is measured by a laser granularity analyzer.

TABLE 1
Granularity of iron powder raw materials used in examples and comparative
examples, and granularity and properties of magnetic powder prepared accordingly

| | | | | | | | | | Property of magnetic | |
|---|---|---|---|---|---|---|---|---|---|---|
| | Iron powder | | | | Magnetic powder | | | | powder | |
| | Granularity/μm | | | | Granularity/μm | | | | | Square |
| | D90 | D50 | D10 | Sphericity | D90 | D50 | D10 | Sphericity | Coercivity/kOe | degree Q |
| Example 1 | 5 | 2.32 | 0.95 | 0.71 | 5 | 2.35 | 0.94 | 0.72 | 11.6 | 0.592 |
| Example 2 | 4.93 | 2.64 | 0.5 | 0.72 | 4.98 | 2.66 | 0.52 | 0.72 | 10.3 | 0.515 |
| Example 3 | 4.43 | 2.01 | 0.53 | 0.72 | 4.52 | 2.02 | 0.58 | 0.74 | 12.8 | 0.523 |
| Example 4 | 4.41 | 1.84 | 0.78 | 0.79 | 4.51 | 1.88 | 0.81 | 0.79 | 13.55 | 0.581 |
| Example 5 | 4.02 | 2.14 | 0.81 | 0.74 | 4.38 | 2.12 | 0.85 | 0.74 | 12.98 | 0.535 |
| Example 6 | 3.91 | 2.05 | 0.8 | 0.78 | 3.95 | 2.07 | 0.82 | 0.78 | 13.04 | 0.582 |
| Example 7 | 3.96 | 1.68 | 0.91 | 0.83 | 3.97 | 1.81 | 0.94 | 0.86 | 14.65 | 0.601 |
| Example 8 | 3.52 | 1.82 | 1.02 | 0.89 | 3.6 | 1.85 | 1.03 | 0.91 | 14.87 | 0.615 |
| Example 9 | 3.04 | 1.7 | 0.89 | 0.85 | 3.09 | 1.78 | 0.9 | 0.85 | 15.02 | 0.608 |
| Example 10 | 2.75 | 1.45 | 0.82 | 0.82 | 2.87 | 1.48 | 0.94 | 0.84 | 15.89 | 0.602 |
| Comparative | 14.52 | 8.78 | 3.67 | 0.84 | 4.55 | 2.02 | 0.92 | 0.41 | 12.15 | 0.448 |
| Example 1 | | | | | | | | | | |
| Comparative | 7.82 | 4.02 | 2.48 | 0.64 | 7.82 | 4.03 | 2.51 | 0.65 | 5.48 | 0.201 |
| example 2 | | | | | | | | | | |
| Comparative | 4.84 | 1.87 | 0.32 | 0.61 | 4.82 | 1.87 | 0.35 | 0.64 | 13.89 | 0.52 |
| example 3 | | | | | | | | | | |

### EXAMPLE 1

(1) 100 g of pure iron powder was taken, the weight of samarium oxide was calculated according to the weight of Sm required for all the iron powder to produce Sm2Fe17 alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4 mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 900° C., and heat preservation was performed for 3 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 3 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 2

(1) 100 g of pure iron powder was taken, the weight of samarium oxide was calculated according to the weight of Sm required for all the iron powder to produce Sm2Fe17 alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Zirconia balls which account for 30% of the volume of the mixed powder and have a diameter of 5 mm were put into a rotating furnace and mixed into the powder, vacuumizing was performed to below 1×10⁻²Pa, argon was inflated to 0.05 MPa, a furnace body was rotated at a speed of 5 r/min, then the temperature was increased to 950° C., and heat preservation was performed for 1 hour.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 3 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 3

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Silicon carbideballs which account for 70% of the volume of the mixed powder and have a diameter of 2 mm were put into a rotating furnace and mixed into the powder, vacuumizing was performed to below 1×10⁻²Pa, argon was inflated to 0.05 MPa, a furnace body was rotated at a speed of 15 r/min, then the temperature was increased to 900° C., and heat preservation was performed for 3 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 3 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm²Fe¹⁷N³ magnetic alloy powder.

The measurement results of the granularity and magnetic property of the powder are shown in Table 1.

### EXAMPLE 4

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Zirconia balls which account for 80% of the volume of the mixed powder and have a diameter of 1mm were put into a rotating furnace and mixed into the powder, vacuumizing was performed to below 1×10⁻²Pa, argon was inflated to 0.05 MPa, a furnace body was rotated at a speed of 20 r/min, then the temperature was increased to 900° C., and heat preservation was performed for 3 hour.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 3 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 5

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 60% of the volume of the mixed powder and have a diameter of 3 mm were put into a rotating furnace and mixed into the powder, vacuumizing was performed to below 1×10⁻²Pa, argon was inflated to 0.05 MPa, a furnace body was rotated at a speed of 15 r/min, then the temperature was increased to 900° C., and heat preservation was performed for 2 hours.

(3) The furnace temperature was reduced to 420° C., vacuumizing was performed to below 1×10⁻²Pa, a pure ammonia gas was introduced for nitriding, and after nitriding was performed for 1 hour, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 6

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Zirconia balls which account for 80% of the volume of the mixed powder and have a diameter of 1mm were put into a rotating furnace and mixed into the powder, vacuumizing was performed to below 1×10⁻²Pa, argon was inflated to 0.05 MPa, a furnace body was rotated at a speed of 20 r/min, then the temperature was increased to 900° C., and heat preservation was performed for 3 hour.

(3) The furnace temperature was reduced to 500° C., vacuumizing was performed to below 1×10⁻²Pa, pure nitrogen was introduced for nitriding, and after nitriding was performed for 15 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C.in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 7

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 880° C., and heat preservation was performed for 2 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 1.5 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60ºC in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 8

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4 mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 860° C., and heat preservation was performed for 1.5 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 1.5 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 9

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 850° C., and heat preservation was performed for 2 hours.

(3) The furnace temperature was reduced to 400° C., vacuumizing was performed to below 1×10⁻²Pa, a mixed gas of ammonia gas and hydrogen with a mixed ratio of 1:1 was introduced for nitriding, and after nitriding was performed for 2 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

The measurement results of the granularity and magnetic property of the powder are shown in Table 1.

### EXAMPLE 10

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4 mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 870° C., and heat preservation was performed for 1 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 1.5 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

The measurement results of the granularity and magnetic property of the powder are shown in Table 1.

### COMPARATIVE EXAMPLE 1

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4 mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 900° C., and heat preservation was performed for 3 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 3 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

(5) The obtained magnetic alloy powder was put into a ball-milling tank, ball milling was performed for 20 hours under the conditions that a ball-material ratio was 30:1, absolute ethanol was a medium and the rotating speed was 300 r/min, and the powder and the solvent were separated in the glove box and subjected to vacuum drying to obtain the final anisotropic Sm₂Fe₁₇N₃ magnetic alloy powder.

The measurement results of the granularity and magnetic property of the powder are shown in Table 1.

COMPARATIVE EXAMPLE 2

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4 mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 900° C., and heat preservation was performed for 3 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 3 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

(5) The obtained magnetic alloy powder was put into a ball-milling tank, ball milling was performed for 20 hours under the conditions that a ball-material ratio was 30:1, absolute ethanol was a medium and the rotating speed was 300 r/min, and the powder and the solvent were separated in the glove box and subjected to vacuum drying to obtain the final anisotropic Sm₂Fe₁₇N₃ magnetic alloy powder.

The measurement results of the granularity and magnetic property of the powder are shown in Table 1.

COMPARATIVE EXAMPLE 3

(1) 100 g of pure iron powder was taken, the weight of samarium oxide was calculated according to the weight of Sm required for all the iron powder to produce Sm₂Fe₁₇ alloy, the samarium oxide was weighed in an amount which is 50% of the weight of the samarium oxide, the weight of calcium granules was calculated according to a reduction reaction and the weight of the samarium oxide, and the calcium granules were weighed in an amount which is 100% of the weight of the calcium granules. The granularity of the iron powder is measured as shown in Table 1; the granularity D90 of the samarium oxide is below 5 μm; and the size of the calcium granules is below 2 mm.

(2) Hard alloy balls which account for 50% of the volume of the mixed powder and have a diameter of 4 mm were put into a rotating furnace and mixed into the powder, vacuumizing was performed to below 1×10⁻²Pa, argon was inflated to 0.05 MPa, a furnace body was rotated at a speed of 10 r/min, then the temperature was increased to 860° C., and heat preservation was performed for 1.5 hours.

(3) The furnace temperature was reduced to 420° C., vacuumizing was performed to below 1×10⁻²Pa, a mixed gas of ammonia gas and hydrogen with a mixed ratio of 1:1 was introduced for nitriding, and after nitriding was performed for 1.5 hours, vacuumizing and heat treatment were performed for 1 hour for homogenization.

(4) After the powder was cooled, the material was taken out and put into a glove box in the argon atmosphere, the balls were filtered out with a filter screen while the powder was washed with deionized water, and the balls could be used next time after being cleaned and dried. The powder was washed with the deionized water until the washing liquid is basically clear, the powder was washed with a dilute acetic acid solution for at least 10 minutes, then the powder was washed with deionized water until the PH value of the washing liquid is about 7, the powder was washed with alcohol for three times finally, and the wet powder was heated to 60° C. in a vacuum environment and dried for 2 hours to finally obtain the anisotropic Sm₂Fe₁₇N₃ magnetic alloy powder.

(5) The obtained magnetic alloy powder was put into a ball-milling tank, ball milling was performed for 20 hours under the conditions that a ball-material ratio was 30:1, absolute ethanol was a medium and the rotating speed was 300 r/min, and the powder and the solvent were separated in the glove box and subjected to vacuum drying to obtain the final anisotropic Sm₂Fe₁₇N₃ magnetic alloy powder.

The measurement results of the granularity and magnetic property of the powder are shown in Table 1.

It can be seen from Examples 1-10 in Table 1 that by the preparation method provided by the present application, the powder characteristic of the raw material iron powder can be effectively retained, thereby achieving greater coercivity and high square degree. It can be seen from the examples and the comparative examples that the anisotropic Sm₂Fe₁₇N₃ magnetic powder with good granularity distribution and morphology has more excellent properties.

The examples of the present application aims to protect anisotropic samarium-iron-nitrogen magnetic alloy powder and a preparation method therefor, and has the following effects.

Firstly, the Sm₂Fe₁₇N₃ magnetic alloy powder provided by the present application has the advantages that: the square degree value is significantly increased through optimized granularity matching and good powder morphology under the condition of the same grain size, such that the magnetic powder shows more excellent comprehensive magnetic properties.

Secondly, in the preparation method provided by the present application, the reductive diffusion and nitriding are performed in the rotating heat treatment furnace, and the high-temperature-resistant balls for avoiding powder sintering are added, so that the alloy powder still can basically maintain the granularity and morphology similar to those of the raw material iron powder event after high-temperature heat treatment, thereby greatly facilitating the control of the morphology and granularity of the anisotropic Sm2Fe1N3 magnetic alloy powder.

Thirdly, in the preparation method provided by the present application, the reductive diffusion and nitriding heat treatment are completed at one step, after the reductive diffusion step is completed, the temperature is directly reduced to a nitriding heat treatment temperature for nitriding, not like the traditional method which is to cool the product to room temperature after the reductive diffusion step is completed, perform crushing, washing and drying, and reheating for nitriding, thereby simplifying the process and saving energy.

Lastly, the present application adopts the iron powder with super-fine granularity and high sphericity, the magnetic alloy powder obtained by the preparation method provided by the present application basically inherits the granularity and morphology of the iron powder, thereby avoiding the fine-grinding step that is necessarily performed in the past to achieve high coercivity, simplifying the process and avoiding the safety problem easily caused by the use of the organic solvent.

It should be understood that, the foregoing specific examples of the present application are only used to illustrate or explain the principle of the present application, but not to limit the present application. Therefore, any modification, equivalent replacement, improvement and the like made without departing from the spirit and scope of the present application should be included within the protection scope of the present application. In addition, the appended claims of the present application are intended to cover all changes and modifications that fall within the scope and boundary of the appended claims, or equivalence of such scope and boundary.

What is claimed is:

1. Anisotropic samarium-iron-nitrogen magnetic alloy powder, having a chemical formula of Sm₂Fe₁₇N₃ and having a Th₂Zn₁₇ crystal structure, wherein in the alloy powder, a granularity is: 0.5 μm≤D90≤5 μm and 0.1 μm≤D10≤2 μm, an average sphericity is greater than or equal to 0.7, a coercivity Hcj is greater than or equal to 10 kOe, and a square degree Q is greater than or equal to 0.5.

2. The anisotropic samarium-iron-nitrogen magnetic alloy powder according to claim 1, wherein
in the alloy powder, the granularity is: 1 μm≤D90≤4 μm and 0.8 μm≤D10≤2 μm, the average sphericity is greater than or equal to 0.8, the coercivity Hcj is greater than or equal to 13 kOe, and the square degree Q is greater than or equal to 0.6.

3. A preparation method for anisotropic samarium-iron-nitrogen magnetic alloy powder, comprising:
S1: mixing raw materials: mixing iron powder, samarium oxide powder and calcium granules uniformly to obtain a mixture;
S2: performing reductive diffusion heat treatment: placing the mixture into a rotating heat treatment furnace, adding high-temperature-resistant balls, performing vacuumizing to 1×10-²Pa, introducing a reductive diffusion protective gas, heating a furnace body to 850° C.-950° C., and performing heat preservation for 1-3 hours;
S3: performing nitriding heat treatment: cooling the furnace body to 400° C.-500° C., performing vacuumizing to 1×10⁻²Pa, introducing a nitriding protective gas, performing heat preservation for 1-15 hours, performing vacuumizing and heat treatment for 1 hour, and cooling; and
S4: washing and drying: taking out and separating the cooled powder and balls, washing the powder, and drying the powder in a vacuum environment to obtain the anisotropic samarium-iron-nitrogen magnetic alloy powder.

4. The preparation method for anisotropic samarium-iron-nitrogen magnetic alloy powder according to claim 3, wherein in S1, a granularity of the iron powder is: 0.5 μm≤D90≤5 μm and 0.1 μm≤D10≤2 μm, a sphericity of the iron powder is greater than or equal to 0.7, a granularity of the samarium oxide is: 0.5 μm≤D90≤5 μm, and a size of the calcium granules is greater than or equal to 0.1 mm and less than or equal to 2 mm.

5. The preparation method for anisotropic samarium-iron-nitrogen magnetic alloy powder according to claim 3, wherein in S1, a granularity of the iron powder is: 1 μm≤D90≤4 μm and 0.8 μm≤D10≤2 μm, a sphericity of the iron powder is greater than or equal to 0.8, a granularity of the samarium oxide is: 1 μm≤D90≤4 μm, and a size of the calcium granules is greater than or equal to 0.1 mm and less than or equal to 1 mm.

6. The preparation method for anisotropic samarium-iron-nitrogen magnetic alloy powder according to claim 3, wherein in S2, the high-temperature-resistant balls account for 20%-80% of the volume of the mixed magnetic alloy powder, and the diameter of the high-temperature-resistant balls is 1-5 mm.

7. The preparation method for anisotropic samarium-iron-nitrogen magnetic alloy powder according to claim 3, wherein in S2, the high-temperature-resistant balls account for 40%-60% of the volume of the mixed magnetic alloy powder, and the diameter of the high-temperature-resistant balls is 2-3 mm.

8. The preparation method for anisotropic samarium-iron-nitrogen magnetic alloy powder according to claim 3, wherein in S2, the high-temperature-resistant balls adopt hard allow balls, zirconia balls or corundum balls.

9. The preparation method for anisotropic samarium-iron-nitrogen magnetic alloy powder according to claim 3, wherein in S2, the furnace body of the heat treatment furnace rotates at a speed of 5-20 r/min.

10. The preparation method for anisotropic samarium-iron-nitrogen magnetic alloy powder according to claim 3, wherein in S3, the nitriding protective gas adopts nitrogen or a mixed gas of nitrogen and hydrogen or an ammonia gas or a mixed gas of an ammonia gas and hydrogen.

11. The preparation method for anisotropic samarium-iron-nitrogen magnetic alloy powder according to claim 3, wherein in S4, the method for taking out and separating the cooled powder and balls comprises:
taking out the cooled powder and balls together, performing washing with deionized water under the protection of an inert gas, and separating the high-temperature-resistant balls by a filter screen.

12. The preparation method for anisotropic samarium-iron-nitrogen magnetic alloy powder according to claim 3, wherein in S4, the method for washing the powder comprises:
washing the powder for many times until the solution is clear, dissolving the residual calcium or compound thereof with dilute acetic acid, performing washing with deionized water until the PH value of the washing liquid is 7, and performing washing with absolute ethanol for several times.
